(19) United States
(12) Patent Application Publication
(10) Pub. No.: US 2016/0079715 A1
(43) Pub. Date: Mar. 17, 2016

(54) TERMINAL FITTING AND ITS MANUFACTURING METHOD, AND CONNECTOR USING THE TERMINAL FITTING

(71) Applicant: YAZAKI CORPORATION, Tokyo (JP)

(72) Inventor: Keigo Tsubo, Shizuoka (JP)

(21) Appl. No.: 14/947,507

(22) Filed: Nov. 20, 2015

Related U.S. Application Data
(63) Continuation of application No. PCT/JP2014/066685, filed on Jun. 24, 2014.

(30) Foreign Application Priority Data
Jun. 26, 2013 (JP) 2013-134087

(51) Int. Cl. H01R 13/66; H01R 43/20

(52) U.S. Cl. CPC H01R 13/665; H01R 43/205

(57) ABSTRACT

A terminal fitting and its manufacturing method, and a connector using the terminal fitting are provided. The terminal fitting includes a first connection terminal portion, a second connection terminal portion including a pattern contact portion provided on one side of an arm extending from the first connection terminal portion, and a circuit body pressing arm forming a gap between itself and the pattern contact portion to press a conductor pattern of a flexible printed circuit board inserted into the gap toward the pattern contact portion. The pattern contact portion is a portion of a surface of a contact portion plate section, the contact portion plate section being punched in a one piece together with the arm so as to be contiguous with one side of the arm and bent in a plate thickness direction of the arm such that the a surface of a contact portion plate section face the circuit body pressing arm.

### CROSS REFERENCE TO RELATED APPLICATIONS

This application is a continuation of International Patent Application No. PCT/JP2014/066685 filed on Jun. 24, 2014, claiming priority from Japanese Patent Application No. 2013-134087 filed on Jun. 26, 2013, the contents of which are incorporated herein by reference.

### FIELD OF INVENTION

The present invention relates to a terminal fitting and its manufacturing method, and a connector using the terminal fitting.

### BACKGROUND ART

FIG. 10 illustrates a connector 100 disclosed in JP2012-199084A. The connector 100 is mounted on a circuit board and a flexible printed circuit board (hereinafter, abbreviated as an FPC) 110 is connected thereto.

The FPC 110 is formed with a connector coupling portion 111 on one surface at a distal end thereof. On the other surface, a slider 112 serving also as a reinforcement is provided in a layer manner. On the connector coupling portion 111 of the FPC 110, a plurality of conductor patterns 111a is arranged at a predetermined pitch.

The connector 100 has a printed circuit board insertion portion 102 into which the FPC 110 is inserted and opened at the front face of a resin housing 101 fixed to a circuit board (not shown). Inside the printed circuit board insertion portion 102, a plurality of terminal fittings 120 connected to a conductor pattern 111a of the FPC 110 is arranged.

The terminal fitting 120 is made from a metal plate, and includes a first connection terminal portion 121 having one end (the right end in FIG. 10) connected to a circuit on a circuit board (not shown), a second connection terminal portion 122 extending from the other end of the first connection terminal portion 121, and a circuit body pressing arm 123 extending from the other end of the first connection terminal portion 121.

The second connection terminal portion 122 is configured such that a pattern contact portion 122b contacting the conductor pattern 111a on the surface of the FPC 110 is formed in a protruding manner on one side (the upper side in FIG. 10) of an arm 122a extending from the other end of the first connection terminal portion 121.

The circuit body pressing arm 123 extends from the other end of the first connection terminal portion 121 to form a gap S1 between itself and the pattern contact portion 122b into which the FPC 110 can be inserted. The circuit body pressing arm 123 presses the slider 112 of the FPC 110 inserted into the gap S1 toward the pattern contact portion 122b.

The terminal fitting 120 is formed by punching a metal plate in a one-piece structure in which the first connection terminal portion 121, the second connection terminal portion 122, and the circuit body pressing arm 123 are connected together in plane.

However, according to this terminal fitting 120, the pattern contact portion 122b is an edge formed by punching of a metal plate. Thus, at the time that the FPC 110 is inserted into the gap S1, rubbing against the pattern contact portion 122b easily causes scraping of the plating on the surface of the conductor pattern 111a of the FPC 110. As a result, scratches easily occur in the conductor pattern 111a. Thus, there has been a possibility that the scratches formed in the conductor pattern 111a due to the friction with the pattern contact portion 122b degrade the electric connection performance.

As a countermeasure for preventing the occurrence of such a drawback, a grinding may be performed on the pattern contact portion 122b. However, a grinding is a machining process essentially different from the press working and hence there has been a problem that the addition of the grinding causes a remarkable cost increase.

### SUMMARY

Illustrative aspects of the present invention provide a terminal fitting which can maintain stable connection to the circuit body by suppressing a conductor pattern of a circuit body from being damaged by a pattern contact portion, without performing a costly grinding. Other illustrative aspects of the present invention provide a method for manufacturing the terminal fitting in an efficient manner. Other illustrative aspects of the present invention provide a connector in which the terminal fitting is used so that connection work of a circuit body can be made easy.

According to an illustrative aspect of the present invention, a terminal fitting includes a first connection terminal portion having one end connected to a first circuit, a second connection terminal portion including a pattern contact portion provided on one side of an arm extending from another end of the first connection terminal portion to contact a conductor pattern on a surface of a circuit body, and a circuit body pressing arm extending from the other end of the first connection terminal portion to form a gap between the circuit body pressing arm and the pattern contact portion, allowing the circuit body to be inserted into the gap, and to press the circuit body inserted into the gap toward the pattern contact portion. The pattern contact portion is a portion of a surface of a contact portion plate section, the contact portion plate section being punched in a one piece together with the arm so as to be contiguous with one side of the arm and bent in a plate thickness direction of the arm such that the surface of the contact portion plate section faces the circuit body pressing arm.

According to another illustrative aspect of the present invention, a method for manufacturing the terminal fitting described above is provided. The method includes a punching step of forming a terminal base metal by punching a metal plate, the terminal base metal having a plurality of terminal base plates arranged at a constant pitch on one side of a carrier plate, each of the terminal base plates having the first connection terminal portion, the second connection terminal portion, the circuit body pressing arm, and the contact portion plate section that are expanded in a planar manner, a bending step of bending the contact portion plate section of each of the terminal base plates in the plate thickness direction of the arm to form the terminal base plates into the terminal fittings, and a cutting step of cutting off the plurality of terminal base plates or the terminal fittings connected to the carrier plate from the carrier plate.

According to an illustrative aspect of the present invention, a connector includes a circuit body insertion portion into which a connector coupling portion of a circuit body on which a plurality of conductor patterns is arranged at a predetermined pitch is inserted, and a plurality of terminal fittings arranged inside the circuit body insertion portion to contact the respective conductor patterns of the circuit body inserted into the circuit body insertion portion. Each of the plurality of terminal fittings arranged inside the circuit body insertion portion is the terminal fitting described above.

According to the configuration described above, the pattern contact portion that contacts the conductor pattern of the circuit body is not an edge formed by punching but is a portion of the surface of the contact portion plate section formed to face the circuit body pressing arm by bending. The surface of the contact portion plate section is a surface obtained at the time of forming the metal plate material by rolling. Thus, the pattern contact portion has sufficient smoothness even without grinding. Thus, it is free from damaging the conductor pattern even when the pattern contact portion is rubbed against the conductor pattern.

Thus, stable connection to the circuit body can be maintained by suppressing the conductor pattern of the circuit body from being damaged by the pattern contact portion, without performing a costly grinding.

Here, as the circuit body in the present invention, an FPC (flexible printed circuit board), an FFC (flexible flat cable), a PC (printed circuit board), or the like may be employed.

According to the configuration described above, the punching step is performed first and then the bending step is performed on the terminal base metal produced in the punching step, so that a workpiece is formed in which a plurality of terminal fittings are arranged at a constant pitch on one side of the carrier plate. Then, the cutting step is performed on the workpiece so that the plurality of terminal fittings is separated from the carrier plate. By virtue of this, the plurality of terminal fittings can efficiently be produced.

Here, depending on the situation, after the punching step, a cutting step may be performed so that a plurality of terminal base plates separated from the carrier plate may be produced. Then, a bending step may be performed on each terminal base plate so that the terminal fittings may be obtained.

According to the configuration described above, the plurality of terminal fittings arranged inside the circuit body insertion portion of the connector have sufficient smoothness in the pattern contact portion. Thus, at the time of inserting the circuit body into the circuit body insertion portion, the conductor pattern of the circuit body is prevented from being damaged by a friction with the pattern contact portion. Thus, at the time of insertion operation of the circuit body, not so much carefulness is required and hence connection work of the circuit body can be made easy.

### Effect of the Invention

According to the terminal fitting of the present invention, stable connection to the circuit body can be maintained by suppressing the conductor pattern of the circuit body from being damaged by the pattern contact portion, without performing a costly grinding.

Further, according to the method for manufacturing the terminal fitting of the present invention, the terminal fitting according to the present invention can efficiently be produced.

Further, according to the connector of the present invention, connection work for a circuit body can be made easy.

The present invention has briefly been described above. Details of the present invention will further be apparent by reading through the embodiments of the invention (hereinafter “embodiments”) described below with reference to the accompanying drawings.

### BRIEF DESCRIPTION OF THE DRAWINGS

FIG. 1 is a perspective view of a connector according to an embodiment of the present invention;

FIG. 2 is an enlarged view of the connector shown in FIG. 1 in a partially cut state;

FIG. 3 is a sectional view illustrating a connection between the connector and an FPC shown in FIG. 1;

FIG. 4 is a perspective view of a terminal fitting held inside the connector shown in FIG. 3;

FIG. 5 is a perspective view of the terminal fitting shown in FIG. 4, viewed from another angle;

FIG. 6 is a side view of the terminal fitting shown in FIG. 5;

FIG. 7 is a plan view of a terminal base metal produced by a punching step at the time of manufacturing the terminal fitting of the embodiment;

FIG. 8 is a perspective view of the terminal base metal shown in FIG. 7;

FIG. 9A is a perspective view of a modified example of the terminal fitting viewed from the front and from obliquely above, and FIG. 9B is another perspective view of the terminal fitting viewed from the rear and from obliquely above; and

FIG. 10 is a sectional view of a connector containing a conventional terminal fitting.

### DETAILED DESCRIPTION

Hereinafter, a terminal fitting, its manufacturing method, and a connector using the terminal fitting according to preferred embodiments of the present invention will be described in detail with reference to the drawings.

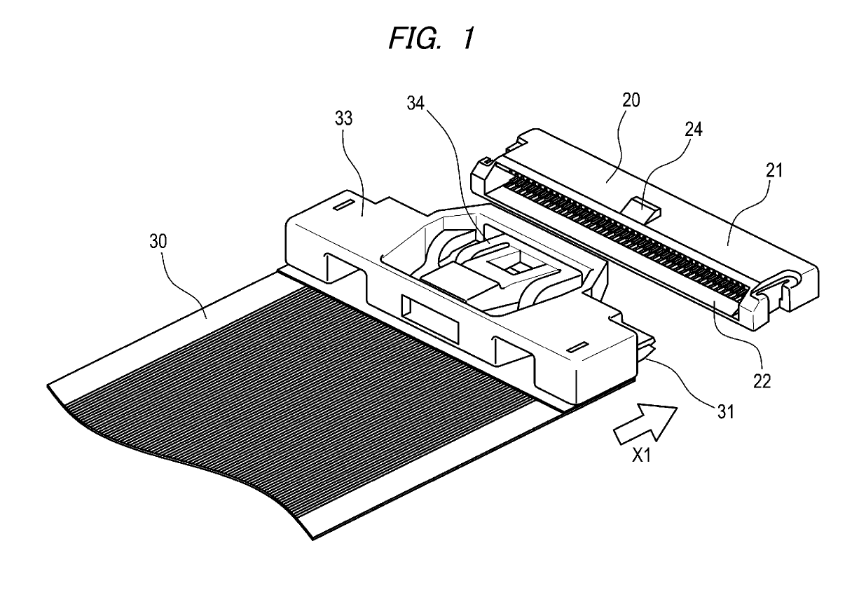

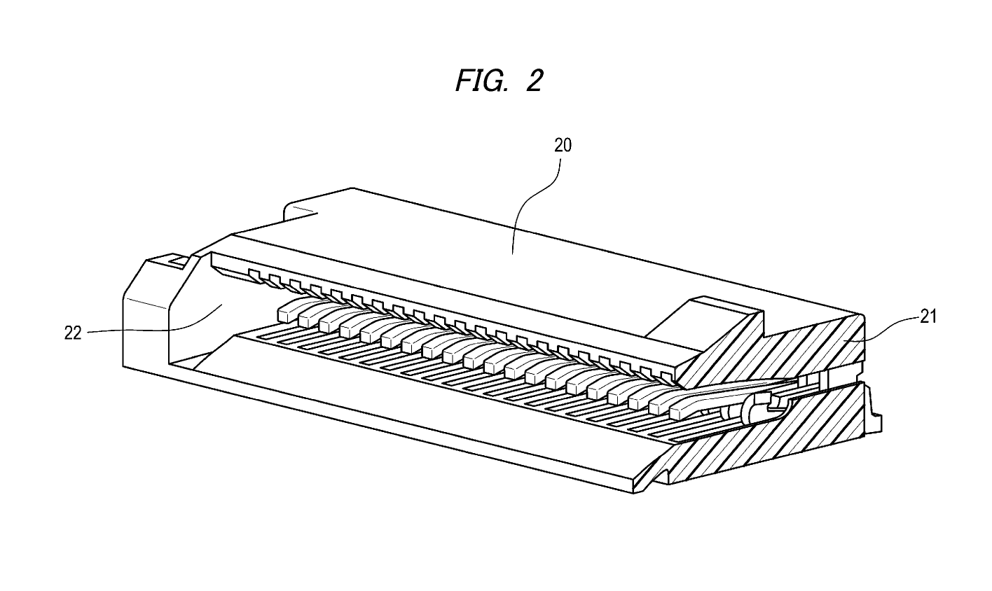

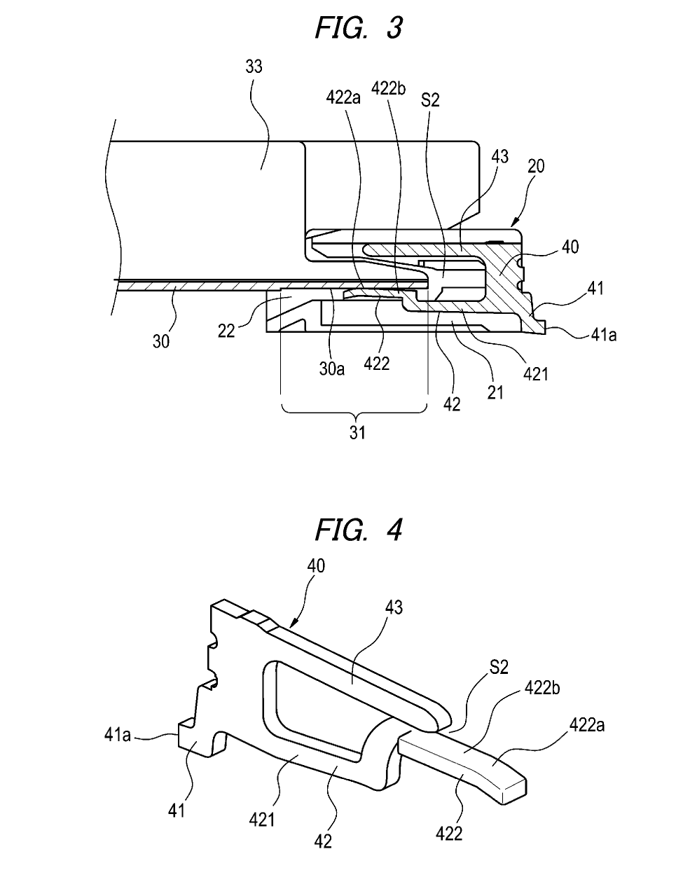

FIGS. 1 to 3 show a connector employing terminal fittings according to the present invention. FIG. 1 is a perspective view of the connector according to an embodiment of the present invention, FIG. 2 is an enlarged view of the connector shown in FIG. 1 in a partially cut state, and FIG. 3 is a sectional view illustrating a connection between the connector and an FPC shown in FIG. 1.

The connector 20 according to this embodiment is a board connector to be mounted on a circuit board (not shown), and a printed circuit board insertion portion 22 is opened at the front face of a resin housing 21 to be fixed to the circuit board. As indicated by an arrow X1 in FIG. 1, a connector coupling portion 31 of an FPC 30 is inserted into the printed circuit board insertion portion 22.

The connector coupling portion 31 is a portion formed on one surface 30a (the lower surface in FIG. 3) at the distal end of the FPC 30. In the connector coupling portion 31, a plurality of conductor patterns of the FPC 30 are arranged at a predetermined pitch. In this connector coupling portion 31, the plurality of arranged conductor patterns are exposed. In the FPC 30, the plurality of conductor patterns is covered by an insulating resin layer in the portion other than the connector coupling portion 31.

On the other surface (the upper face in FIG. 3) at the distal end of the FPC 30, a slider 33 is fixed. The slider 33 is fixed to the distal end portion of the FPC 30 to provide a certain strength to the connector coupling portion 31. The slider 33 includes a lock arm 34 to achieve coupling with the connector 20. When the connector coupling portion 31 is properly inserted into the printed circuit board insertion portion 22, the lock arm 34 engages with a lock projection 24 on the housing 21 to fix the slider 33 to the housing 21.

A plurality of terminal fittings 40 are installed in the inside of the printed circuit board insertion portion 22 of the connector 20. The plurality of terminal fittings 40 in the printed circuit board insertion portion 22 are installed at the same arrangement pitch as the arrangement pitch of the conductor patterns on the connector coupling portion 31 contact the respective conductor patterns of the connector coupling portion 31 inserted into the printed circuit board insertion portion 22.

As shown in FIGS. 4 to 6, the terminal fitting 40 includes a first connection terminal portion 41 a second connection terminal portion 42, and a circuit body pressing arm 43.

The first connection terminal portion 41 is connected to a first circuit on a circuit board on which the connector 20 is mounted at one end 41a thereof.

The second connection terminal portion 42 has a pattern contact portion 422a provided on one side (the upper side in FIG. 6) 421a of an arm 421 extending from the other end of the first connection terminal portion 41. The pattern contact portion 422a is a portion that contacts the conductor pattern on the surface of the connector coupling portion 31.

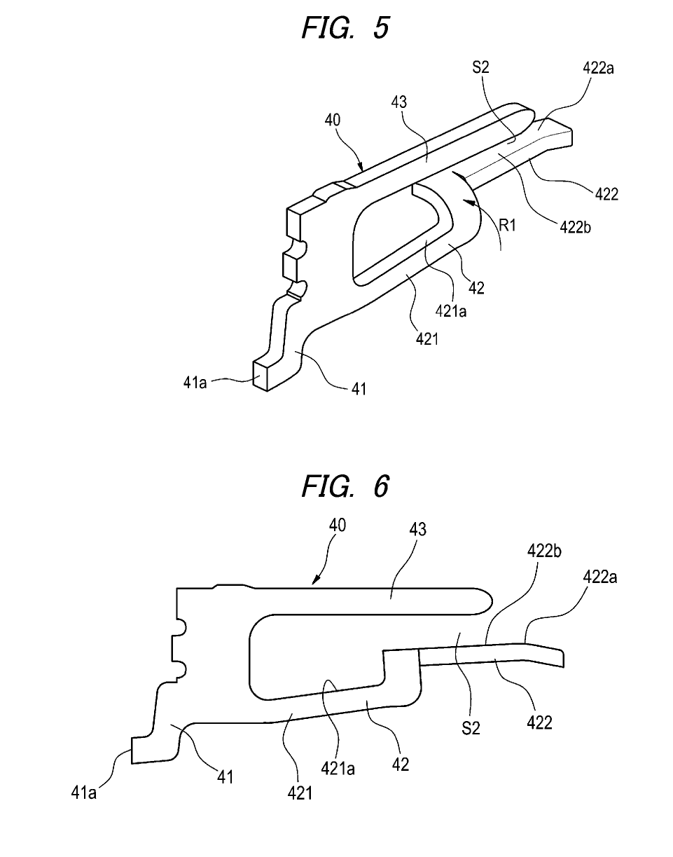

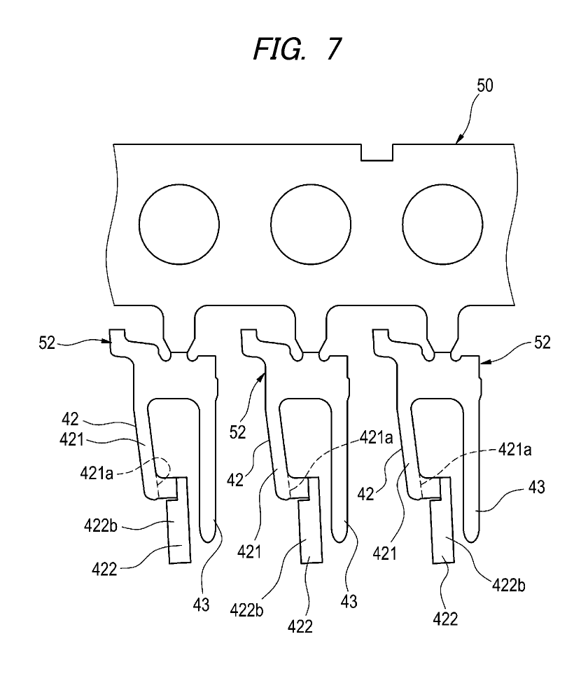

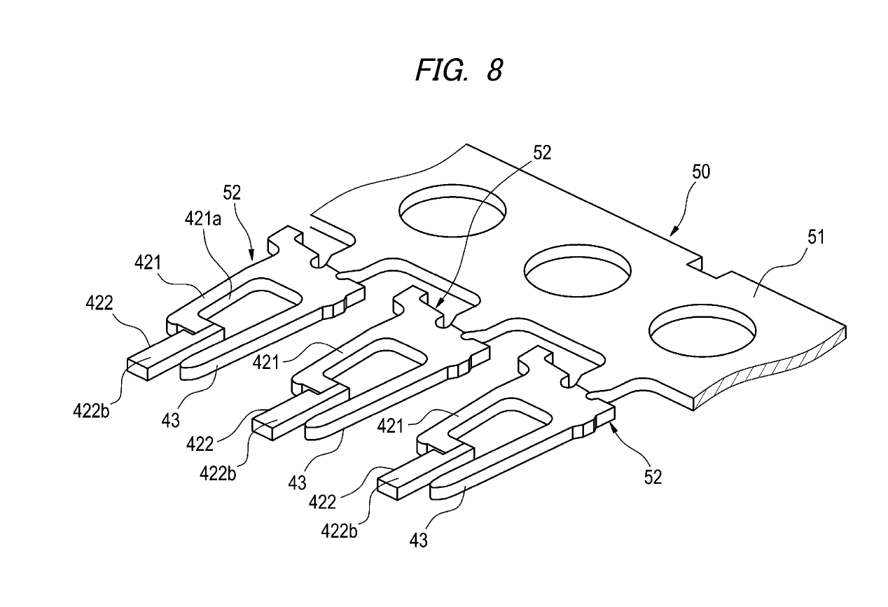

According to the present embodiment, as shown in FIGS. 7 and 8, the pattern contact portion 422a is provided by a contact portion plate section 422 punched in a one piece together with the arm 421 so as to be contiguous with one side 421a of the arm 421. The pattern contact portion 422a is a portion of the surface 422b of the contact portion plate section 422 formed to face the circuit body pressing arm 43 by bending (twisting and bending) the contact portion plate section 422 in the plate thickness direction of the arm 421 as indicated by an arrow R1 in FIG. 5.

The circuit body pressing arm 43 extends from the other end of the first connection terminal portion 41 to forma gap S2 between itself and the pattern contact portion 422a into which the FPC 30 can be inserted. As shown in FIG. 3, the circuit body pressing arm 43 presses the FPC 30 inserted into the gap S2 toward the pattern contact portion 422a.

The terminal fitting 40 of the present embodiment is formed by performing a punching step, a bending step, and a cutting step on a metal plate having a flat plate shape.

Here, the punching step is a step of forming a terminal base metal 50 shown in FIGS. 7 and 8 by punching of a metal plate.

The terminal base metal 50 has a structure that a plurality of terminal base plates 52 are arranged at a constant pitch on one side of a carrier plate 51.

The plurality of terminal base plates 52 have a structure that the first connection terminal portion 41, the arm 421, the circuit body pressing arm 43, and the contact portion plate section 422 are expanded in a planar manner.

The bending step is a step of bending the contact portion plate section 422 of the terminal base plate 52 in the plate thickness direction of the arm 421 and thereby forming the terminal base plate 52 into the terminal fitting 40.

The bending step may be performed in a state that the terminal base plate 52 is connected to the carrier plate 51 or, alternatively, in a state that each terminal base plate 52 has been separated from the carrier plate 51.

The cutting step is a step of cutting off from the carrier plate 51 the plurality of terminal base plates 52 or terminal fittings 40 connected to the carrier plate 51.

According to the terminal fitting 40 of the embodiment described above, the pattern contact portion 422a that contacts the conductor pattern of the FPC 30 is not an edge formed by punching but is a portion of the surface 422b of the contact portion plate section 422 formed to face the circuit body pressing arm 43 by bending. The surface 422b of the contact portion plate section 422 is a surface obtained at the time of forming the metal plate material by rolling. Thus, the pattern contact portion 422a has sufficient smoothness even without grinding. Thus, it is free from damaging the conductor pattern even when the pattern contact portion is rubbed against the conductor pattern.

Thus, without performing a costly grinding, a situation that the pattern contact portion 422a damages the conductor pattern of the FPC 30 is suppressed so that stable connection to the FPC 30 can be maintained.

Further, in a fabrication method of an embodiment, a punching step is performed first and then a bending step is performed on a terminal base metal 50 produced by the punching step, so that a workpiece is formed in which a plurality of terminal fittings 40 are arranged at a constant pitch on one side of a carrier plate 51. Then, a cutting step is performed on the workpiece so that the plurality of terminal fittings 40 is separated from the carrier plate 51. By virtue of this, the plurality of terminal fittings 40 can efficiently be produced.

Here, depending on the situation, after the punching step, a cutting step may be performed so that a plurality of terminal base plates 52 separated from the carrier plate 51 may be produced. Then, a bending step may be performed on each terminal base plate 52 so that the terminal fittings 40 may be obtained.

Further, in a connector 20 of an embodiment, the plurality of terminal fittings 40 arranged inside the printed circuit board insertion portion 22 have sufficient smoothness in the pattern contact portion 422a. Thus, at the time of inserting the FPC 30 into the printed circuit board insertion portion 22, the conductor pattern of the FPC 30 is prevented from being damaged by friction with the pattern contact portion 422a. Thus, at the time of insertion operation of the FPC 30, not so much carefulness is required and hence connection work of the FPC 30 can be made easy.

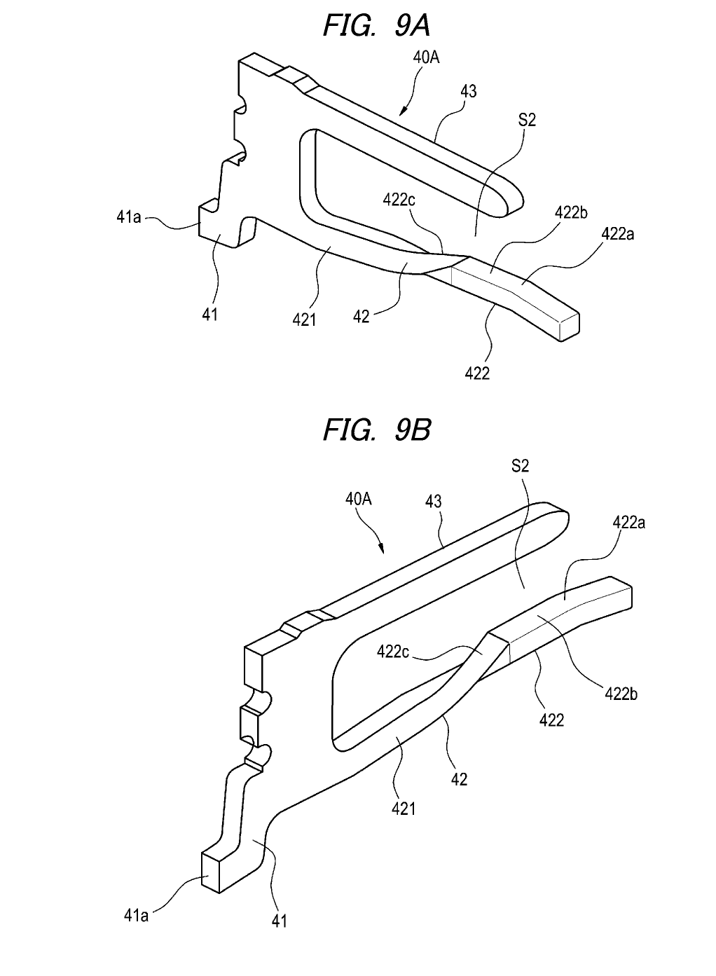

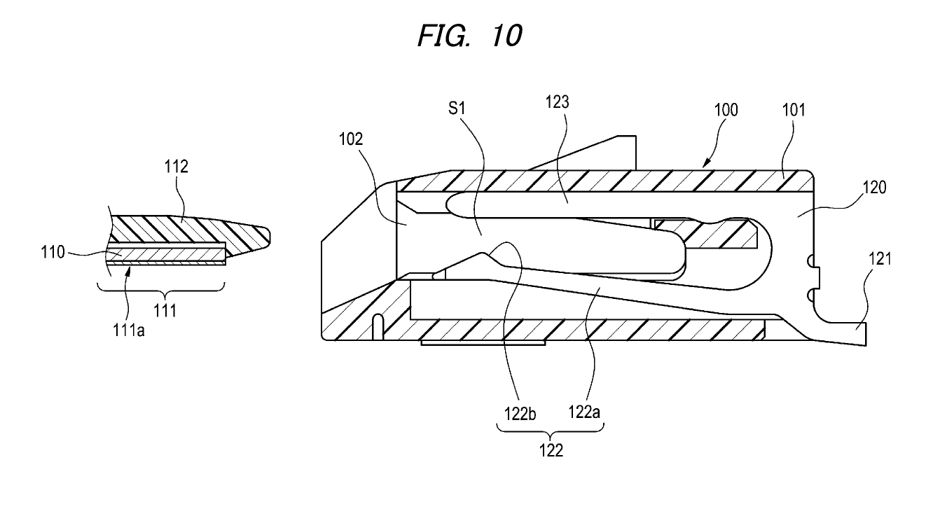

FIG. 9A is a perspective view of a modified example of the terminal fitting viewed from the front and from obliquely above, and FIG. 9B is another perspective view of the terminal fitting viewed from the rear and from obliquely above.

The difference of the terminal fitting 40A from the terminal fitting 40 described above is the configuration of the second connection terminal portion 42. The other points in the configuration are the same. Like configurations are designated by like numerals and their description is omitted.

In the second connection terminal portion 42, the contact portion plate section 422 is formed by twisting the arm 421 rather than bending. That is, in place of the above-mentioned bending step, the contact portion plate section 422 is formed by twisting the contact portion plate section 422 by 90 degrees relative to the arm 421. Then, suitable elasticity is generated by the twisted portion 422c so that appropriate contact with the conductor pattern of the connector coupling portion 31 can be achieved.

The present invention is not limited to the embodiments described above, and changes and modifications may be made therein. In addition, material, shape, dimensions, number, arranging location, and the like of each component in the embodiments described above are optional and are non-limiting, in so far as the present invention can be achieved.

For example, in place of the FPC in the embodiments described above, an FFC (flexible flat cable) or a PC (printed circuit board) may be employed.

Here, features of the terminal fitting, its manufacturing method, and the connector using the terminal fitting according to the embodiments of the present invention described above are briefly summarized and listed in the following.

A terminal fitting (40) has a first connection terminal portion (41) having one end connected to a first circuit; a second connection terminal portion (42) including a pattern contact portion (422a) provided on one side of an arm (421) extending from another end of the first connection terminal portion (41) to contact a conductor pattern on a surface of a circuit body (30); and a circuit body pressing arm (43) extending from the other end of the first connection terminal portion (41) to form a gap (S2) between itself and the pattern contact portion (422a), allowing the circuit body (30) to be inserted into the gap (S2), and to press the circuit body (30) inserted into the gap (S2) toward the pattern contact portion (422a). The pattern contact portion (422a) is a portion of a surface (422b) of a contact portion plate section (422), the contact portion plate section (422) being punched in a one piece together with the arm (421) so as to be contiguous with one side of the arm (421) and bent in a plate thickness direction of the arm (421) such that the surface (422b) of a contact portion plate section (422) faces the circuit body pressing arm (43).

A method for manufacturing the terminal fitting (40) is provided. The method includes a punching step of forming a terminal base metal (50) by punching a metal plate, the terminal base metal (50) having a plurality of terminal base plates (52) arranged at a constant pitch on one side of a carrier plate (51), each of the terminal base plates (52) in which the first connection terminal portion (41), the second connection terminal portion (42), the circuit body pressing arm (43), and the contact portion plate section (422) that are expanded in a planar manner, a bending step of bending the contact portion plate section (422) of each of the terminal base plates (52) in the plate thickness direction of the arm (421) to form the terminal base plates (52) into the terminal fittings (40), and a cutting step of cutting off the plurality of terminal base plates (52) or terminal fittings (40) connected to the carrier plate (51) from the carrier plate (51).

A connector (20) Includes a circuit body insertion portion (22) into which a connector coupling portion (31) of a circuit body (30) on which a plurality of conductor patterns is arranged at a predetermined pitch is inserted, and a plurality of terminal fittings (40) arranged inside the circuit body insertion portion (22) to contact the respective conductor patterns of the circuit body (30) inserted into the circuit body insertion portion (22). Each of the plurality of terminal fittings (40) arranged inside the circuit body insertion portion (22) is the terminal fitting (40) described above.

The present invention has been described in detail with reference to certain embodiments thereof, it is apparent for those skilled in the art that various changes and modifications may be made therein without departing from the spirit and the scope of the present invention.

According to the terminal fitting of the present invention, stable connection to the circuit body can be maintained by suppressing the conductor pattern of the circuit body from being damaged by the pattern contact portion, without performing a costly grinding. The present invention providing this effect is useful in a terminal fitting, its manufacturing method, and a connector using the terminal fitting.

What is claimed is:

1. A terminal fitting comprising:
a first connection terminal portion comprising one end connected to a first circuit;
a second connection terminal portion comprising a pattern contact portion provided on one side of an arm extending from another end of the first connection terminal portion to contact a conductor pattern on a surface of a circuit body; and
a circuit body pressing arm extending from the other end of the first connection terminal portion to form a gap between the circuit body pressing arm and the pattern contact portion, allowing the circuit body to be inserted into the gap, and to press the circuit body inserted into the gap toward the pattern contact portion,
wherein the pattern contact portion is a portion of a surface of a contact portion plate section, the contact portion plate section being punched in a one piece together with the arm so as to be contiguous with one side of the arm and bent in a plate thickness direction of the arm such that the surface of the contact portion plate section faces the circuit body pressing arm.

2. A method for manufacturing a terminal fitting, the terminal fitting comprising a first connection terminal portion having one end connected to a first circuit, a second connection terminal portion having a pattern contact portion provided on one side of an arm extending from another end of the first connection terminal portion to contact a conductor pattern on a surface of a circuit body, and a circuit body pressing arm extending from the other end of the first connection terminal portion to form a gap between the circuit body pressing arm and the pattern contact portion, allowing the circuit body to be inserted into the gap, and to press the circuit body inserted into the gap toward the pattern contact portion, wherein the pattern contact portion is a portion of a surface of a contact portion plate section, the contact portion plate section being punched in a one piece together with the arm so as to be contiguous with one side of the arm and bent in a plate thickness direction of the arm such that the surface of the contact portion plate section faces the circuit body pressing arm, the method comprising:
a punching step of forming a terminal base metal by punching a metal plate, the terminal base metal having a plurality of terminal base plates arranged at a constant pitch on one side of a carrier plate, each of the terminal base plates having the first connection terminal portion, the second connection terminal portion, the circuit body pressing arm, and the contact portion plate section that are expanded in a planar manner;
a bending step of bending the contact portion plate section of each of the terminal base plates in the plate thickness direction of the arm to form the terminal base plates into the terminal fittings; and
a cutting step of cutting off the plurality of terminal base plates or the terminal fittings connected to the carrier plate from the carrier plate.

3. A connector comprising:
a circuit body insertion portion into which a connector coupling portion of a circuit body on which a plurality of conductor patterns is arranged at a predetermined pitch is inserted; and
a plurality of terminal fittings arranged inside the circuit body insertion portion to contact the respective conductor patterns of the circuit body inserted into the circuit body insertion portion,
wherein each of the plurality of terminal fittings comprises:
a first connection terminal portion comprising one end connected to a first circuit;
a second connection terminal portion comprising a pattern contact portion provided on one side of an arm extending from another end of the first connection terminal portion to contact a corresponding one of the conductor patterns on a surface of the circuit body; and
a circuit body pressing arm extending from the other end of the first connection terminal portion to form a gap between the circuit body pressing arm and the pattern contact portion, allowing the circuit body to be inserted into the gap, and to press the circuit body inserted into the gap toward the pattern contact portion,
wherein the pattern contact portion is a portion of a surface of a contact portion plate section, the contact portion plate section being punched in a one piece together with the arm so as to be contiguous with one side of the arm and bent in a plate thickness direction of the arm such that the surface of the contact portion plate section faces the circuit body pressing arm.
